(19) United States
(12) Patent Application Publication
(10) Pub. No.: US 2004/0204171 A1
(43) Pub. Date: Oct. 14, 2004

(54) Mobile power supply device for mobile telephone

(76) Inventor: Chao Ming Chien, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/211,561

(22) Filed: Aug. 5, 2002

(51) Int. Cl. H04M 1/00

(52) U.S. Cl. 455/572; 455/550.1

(57) ABSTRACT

A mobile power supply device is constructed to include a power supply unit, the power supply unit having a battery holder holding at least one battery and a protection and voltage regulation circuit electrically connected in series to the at least one battery; and a connector adapted for connecting the battery holder of the power supply unit to a mobile telephone to transmit battery power from the at least one battery to the mobile telephone through the protection and voltage regulation circuit.

### BACKGROUND OF THE INVENTION

1. Field of the Invention

The present invention relates mobile telephones and, more particularly, to a mobile power supply device for mobile telephone.

2. Description of the Related Art

A mobile telephone uses a rechargeable battery to provide the necessary working voltage. When power low, the rechargeable battery must be charged to the saturated status. Various battery chargers have been disclosed for this purpose, and have appeared on the market FIG. 1 shows a conventional battery charger for mobile telephone. The battery charger comprises a first connector 10′ adapt4ed for connecting to the power Jack of a mobile telephone 20′, and a second connector 12′ adapted for connecting to the socket for cigarette lighter of a motor vehicle. This structure of battery charger cannot actively provide power supply to the mobile telephone connected thereto. When no car battery power available, this structure of battery charger becomes useless

Therefore, it is desirable to provide a mobile power supply device for mobile telephone that can conveniently be carried with the user, and connected to a mobile telephone to provide the mobile telephone with the necessary working voltage when desired.

### SUMMARY OF THE INVENTION

The present invention has been accomplished under the circumstances in view. It is one object of the present invention to provide a mobile power supply device, which can conveniently be carried with the user for use to provide the necessary working voltage to a mobile telephone when power low. It is another object of the present invention to provide a mobile power supply device, which has means to protect the mobile telephone against damage when the battery cell installed in the wrong direction To achieve these and other objects and according to one aspect of the present invention, the mobile power supply device of the present invention comprises a power supply unit, the power supply unit comprising a battery holder holding at least one battery and a protection and voltage regulation circuit electrically connected in series to the at least one battery, and a connector adapted for connecting the battery holder of the power supply unit to a mobile telephone to transmit battery power from the at least one battery to the mobile telephone through the protection and voltage regulation circuit. According to another aspect of the present invention, the mobile power supply device further comprises a protection and voltage regulation circuit installed in the power output end of the power supply unit and adapted to protect the mobile telephone when battery inaccurately installed in the battery holder. According to another aspect of the present invention, the connector has a module plug adapted for connecting to the power supply unit, and the battery holder of the power supply unit has a module jack adapted for receiving the module plug of the connector. According to still another aspect of the present invention, the power supply unit has a swivel hook coupled thereto for hanging.

### BRIEF DESCRIPTION OF THE DRAWINGS

FIG. 1 illustrates the use of a mobile telephone with a battery charger according to the prior art.

FIG. 2 is an exploded view of a mobile power supply device according to the present invention.]

FIG. 3 is an exploded view of an alternate form of the mobile power supply device according to the present invention.

FIG. 4 is a circuit block diagram of the present invention.

FIG. 5 is a circuit diagram of the present invention.

FIG. 6 is a circuit diagram of another alternate form of the present invention.

FIG. 7 is an exploded view of still another alternate form of the present invention.

FIG. 8 is an elevational view of still another alternate form of the mobile power supply device according to the present invention.

FIG. 9 is similar to FIG. 8 but showing the connector received in the receiving open chamber of the power supply unit

FIG. 10 shows the mobile power supply device of FIG. 9 hung on one belt loop of the user's belt

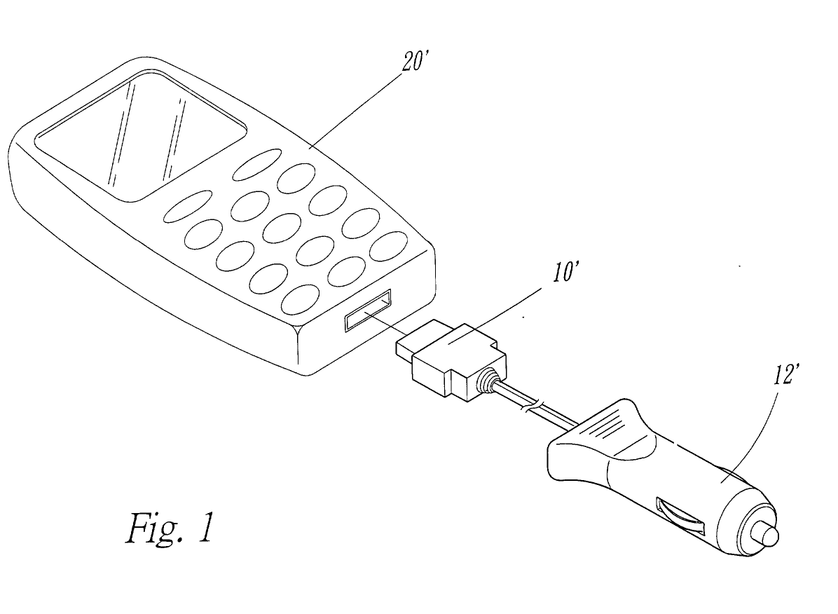

### DETAILED DESCRIPTION OF THE PREFERRED EMBODIMENT

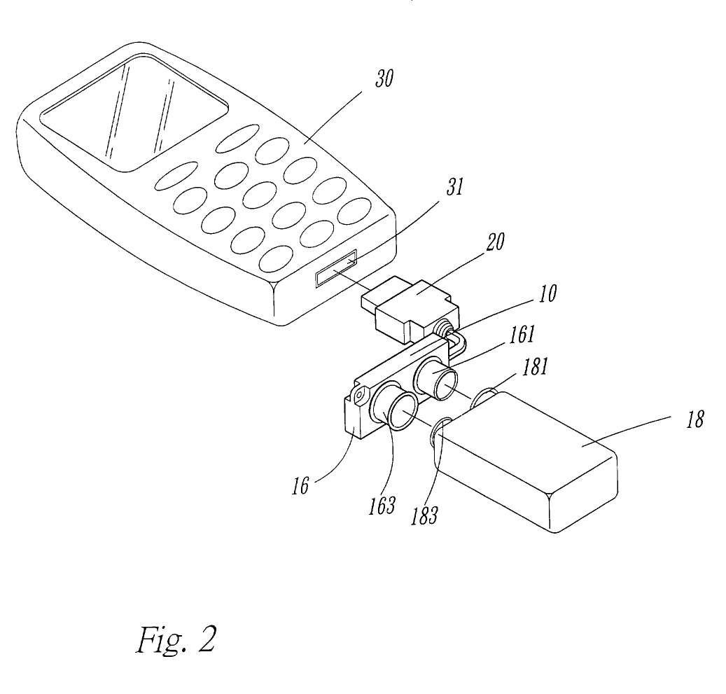

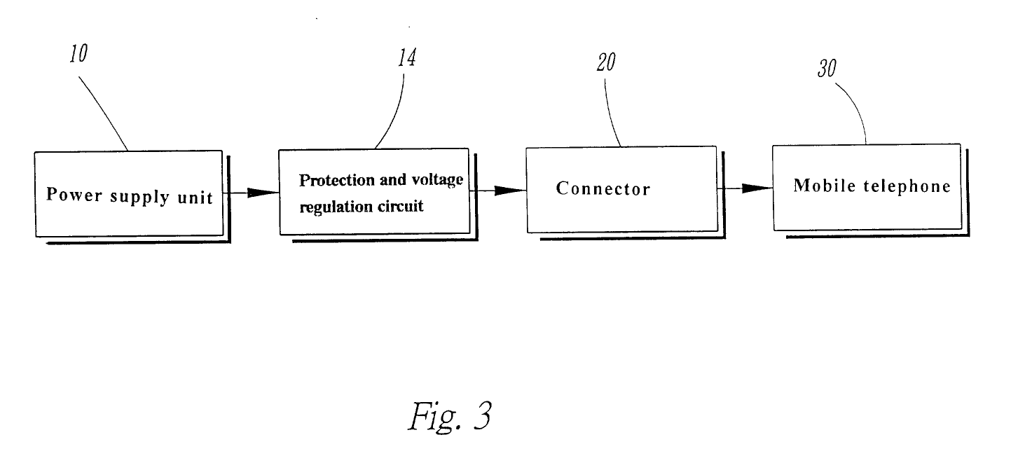

Referring to FIG. 2 a mobile power supply device for mobile telephone in accordance with the present invention is shown comprised of a power supply unit 10 and a connector 20 The connector 20 adapted for connecting the power supply unit 10 to the power jack 31 of a mobile telephone 30 to transmit battery power from the power supply unit 10 to the mobile telephone 30. The power supply unit 10 is comprised of a battery holder 16, and a battery set 18. The battery holder 16 comprises a positive pole contact 161, a negative pole contact 163, and a module jack 165. The positive pole contact 161 and the negative pole contact 163 are respectively electrically connected to the positive pole terminal and negative pole terminal (not shown) of the module jack 165. The battery set 18 has a positive pole contac6t 181 and a negative pole contact 183 adapted for fastening to the positive pole contact 161 and negative pole contact 163 of the battery holder 16. The connector 20 has one end terminating in a module plug 21 adapted for connecting to the module jack 165 of the power supply unit 10 to receive battery power from the battery set 18. According to this embodiment, the battery set 18 is a 9V rectangular battery cell. Alternatively, the battery holder 16 can be made to hold, for example, 3×1.5V battery cells as shown in FIG. 3 The power supply unit 10 further comprises a protection and voltage regulation circuit (not shown) 14 embedded in the battery holder 16 for overvoltage protection and voltage regulation.

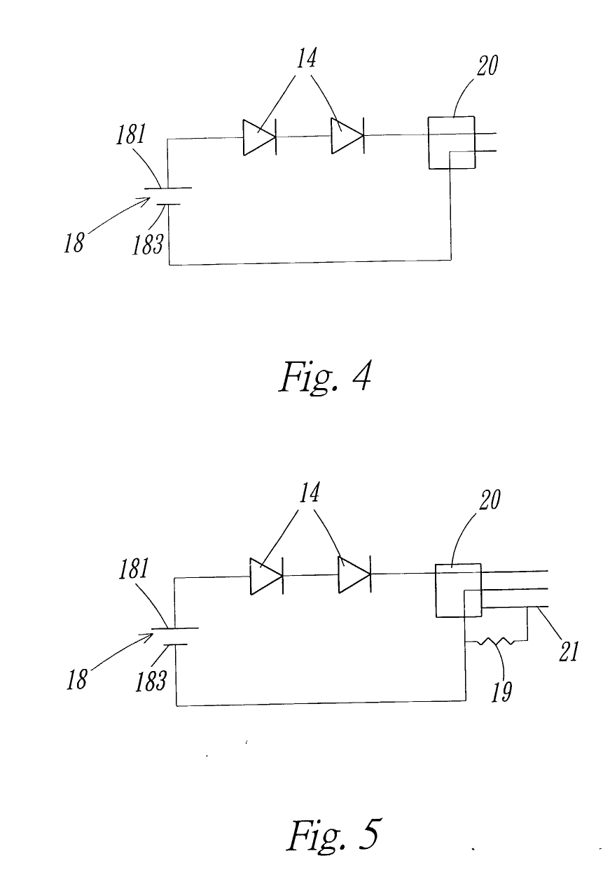

Referring to FIGS. 4 and 5, the aforesaid protection and voltage regulation circuit 14 is connected in series to the battery set 18. In case the battery set 18 is not accurately connected to the battery holder 16, the protection and voltage regulation circuit 14 protects the internal electronic component parts of the mobile telephone 30 against possible damage due to reversed polarity. The protection and voltage regulation circuit 14 can also regulate the voltage of the battery set 18. For example, the protection and voltage regulation circuit 14 regulates the voltage of 9V rectangular battery 18 of FIG. 2 to a voltage level within the acceptable working range of the mobile telephone 30. The connector 20 is connected to the output end of the protection and voltage regulation circuit 14, forming with the protection and voltage regulation circuit 14 and the power circuit of the mobile telephone 30 a loop.

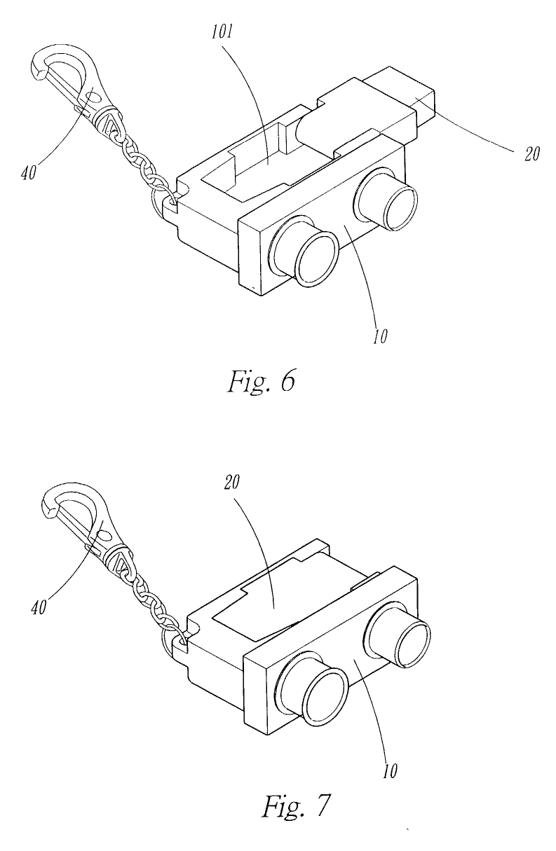

FIG. 6 shows another alternate form of the present invention. According to this embodiment, a noise eliminating circuit, for example, a resistor 19 is provided and connected ill series between the negative pole contact 183 and the grounding terminal of the module plug 21 of the connector 20 for eliminating noises from the circuit.

FIG. 7 shows still another alternate form of the present invention According to this alternate form, the connector 20 is fixedly connected to the battery holder 16 of the power supply unit 10.

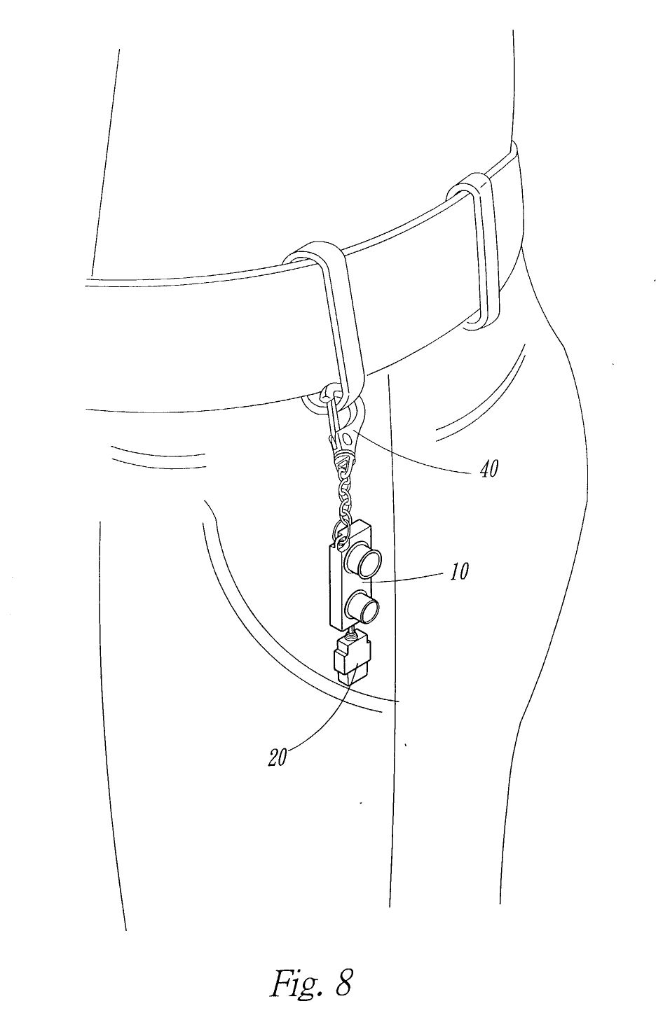

FIGS. 8 and 9 show still another alternate form of the present invention. According to this embodiment, the connector 20 is pivoted to the power supply unit 10. The power supply unit 10 has a receiving open chamber 101 in one side thereof, and a swivel hook 40 coupled thereto for holding a key-ring or hanging on a belt loop of the belt or the like (see FIG. 10). The connector 20 can be received inside the receiving open chamber 101 of the power supply unit 10 when not in use, or turned out of the receiving open chamber 101 for connecting to a mobile telephone.

A prototype of mobile power supply device for mobile telephone has been constructed with the features of FIGS. 2˜10. The mobile power supply device for mobile telephone functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mobile power supply device comprising
a power supply unit, said power supply unit comprising a battery holder holding at least one battery, and a protection and voltage regulation circuit electrically connected in series to said at least one battery; and
a connector adapted for connecting said battery holder of said power supply unit to a mobile telephone to transmit battery power from said at least one battery to the mobile telephone through said protection and voltage regulation circuit.

2. The mobile power supply device as claimed in claim 1, wherein said connector has one end terminating in a module plug; said battery holder of said power supply unit comprises a module jack adapted for receiving the module plug of said connector.

3. The mobile power supply device as claimed in claim 1, wherein said battery holder holds at least one No. 3 battery cell.

4. The mobile power supply device as claimed in claim 1 wherein said battery holder holds at least one No. 4 battery cell.

5. The mobile power supply device as claimed in claim 1, wherein said battery holder holds one 9V rectangular battery cell.

6. The mobile power supply device as claimed in claim 1, wherein said at least one battery cell is connected in series and/or in parallel to said battery holder.

7 The mobile power supply device as claimed in claim 1, wherein said protection and voltage regulation circuit is comprised of at least one diode.

8. The mobile power supply device as claimed in claim 7, wherein said protection and voltage regulation circuit is comprised of two diodes.

9. The mobile power supply device as claimed in claim 1, wherein said power supply unit comprises a swivel hook adapted for hanging

10. The mobile power supply device as claimed in claim 1, wherein said power supply unit comprises a receiving open chamber adapted for receiving said connector; said connector is pivoted to said power supply unit and alternatively turned in and out of said receiving open chamber.

11. The mobile power supply device as claimed in claim 1, wherein said power supply unit further comprises at least one resistor connected in series between the negative pole of said at least one battery and a grounding terminal of said connector.

12 The mobile power supply device as claimed in claim 1, wherein said connector is compatible to the mobile telephone to which said battery holder of said power supply unit is to be connected.
